(19) United States
(12) Patent Application Publication
(10) Pub. No.: US 2019/0321792 A1
(43) Pub. Date: Oct. 24, 2019

(54) STATIC MIXER, A KIT OF PARTS AND USE OF A STATIC MIXER

(71) Applicant: Sulzer Mixpac AG, Haag (CH)

(72) Inventor: Carsten RUSS, Zürich (CH)

(21) Appl. No.: 16/474,741

(22) PCT Filed: Dec. 22, 2017
(86) PCT No.: PCT/EP2017/084407

§ 371 Date: Jun. 28, 2019

(30) Foreign Application Priority Data
Dec. 29, 2016 (EP) 16207396.9

(51) Int. Cl. B01F 5/06; B01F 15/00; B01F 3/10; B67D 3/00

(52) U.S. Cl. CPC B01F 5/0619; B01F 15/0087; B01F 2215/006; B67D 3/0012; B01F 2215/0027; B01F 3/10

(57) ABSTRACT

A mixing inset for a static mixer comprises a plurality of mixing elements which are interconnected by at least one peripheral web wherein the peripheral web is at least partly discontinuous. A static mixer for mixing together at least two components comprises a mixer housing, a mixing inset being arranged at least partly in the mixer housing, The mixing inset further comprises a plurality of mixing elements which are connected by at least one peripheral web which is at least partly discontinuous. A kit of parts comprising a static mixer, a two component cartridge suitable for connecting to said static mixer and for dispensing the two components through said static mixer and mixing said components thereby and optionally a dispensing gun. Using a mixing inset or a static mixer for mixing two component materials.

### CROSS-REFERENCE TO RELATED APPLICATION

This application is a U.S. National Stage application of International Application No. PCT/EP2017/084407, filed Dec. 22, 2017, which claims priority to European Patent Application No. 16207396.9, filed Dec. 29, 2016, the contents of each of which are hereby incorporated herein by reference.

### BACKGROUND

### Field of the Invention

The present invention relates to a mixing inset for a static mixer for mixing two component materials, a static mixer, a kit of parts comprising a static mixer, the method operating a mixing inset and the method operating a static mixer.

### Background Information

For many applications, two-component materials are stored in two separate compartments of cartridges and the components are mixed upon dispensing the content of the cartridges through a static mixer which is attached to the cartridge outlet. After mixing, the components usually react chemically with each other. Such materials are used e.g. for sealing joints, as adhesives, as chemical anchors in construction or as impression materials in the dental sector.

Such static mixers are, for example, described in patents EP0815929B1 and EP2548634B1.

EP0815929B1 discloses a static mixer with a mixer housing and a mixing inset comprising several mixing elements. For increased mechanical stability, these mixing elements are interconnected by two opposing parallel plates in some embodiments. The plates are located directly adjacent to the mixer housing in the assembled state.

EP2548634B1 discloses a static mixer with a mixer housing and a mixing inset comprising several mixing elements. These mixing elements are stabilized by being interconnected by four peripheral webs which are located directly adjacent to the mixer housing in the assembled state.

### SUMMARY

Depending on the materials to be mixed and/or environmental conditions like temperature, it has been found that these prior art static mixers have the disadvantage that they may exhibit specific deficiencies in mixing quality. In particular, streaks of unmixed material in a bead of dispensed material have been observed.

It is an objective of this invention to overcome the deficiencies in the mixing quality of the prior art mixing insets or static mixers, for example, the presence of streaking.

It is another objective of this invention to provide a kit of parts for dispensing and mixing two component materials which overcomes the deficiencies in the mixing quality of the prior art kits, for example, the presence of streaking.

It is another objective of this invention to provide a method for dispensing and mixing two component materials which overcomes the deficiencies in the mixing quality of the prior art kits, for example, the presence of streaking.

This objective is satisfied with a mixing inset for a static mixer, a static mixer, a kit of parts ,and the methods of operating a mixing inset and a static mixer, as discussed herein.

In particular a mixing inset for a static mixer of the present invention is suitable for mixing together at least two components and comprises a plurality of mixing elements which are connected by at least one peripheral web positioned on the periphery of the mixing inset.

The mixing inset of the present invention differs from the prior art such as EP0815929B1 and EP2548634B1 by the feature here that the interconnecting peripheral web is at least partly discontinued or discontinuous.

Providing such a discontinuity in the present invention allows for any undesired flow of material on the outside of the mixing inset to blend with the regular flow which follows a path through the mixing elements. Such an undesired flow may develop in an assembled static mixer wherein the mixing inset is at least partially arranged inside a mixer housing because the dimensions of the mixer housing and the mixing inset are usually chosen such that a small gap of around 0.05 to 0.2 mm is present between the peripheral webs of the mixing inset and the mixer housing for assembly reasons. Furthermore this gap may be wider due to manufacturing tolerances or may increase during operation due to a radial expansion of the mixer housing caused by the pressure of the dispensed materials. Due to the pressure during dispensing, a formation of a gap may even occur when the gap is virtually zero in a pressure-less state. This gap may be entered by some unmixed or poorly mixed material on the inlet side of the static mixer, and in the static mixers of prior art this unmixed or poorly mixed material may propagate all the way to the outlet of the static mixer without being subjected to any further mixing. By blending these undesired flows with the regular flow which follows a path through the mixing elements, the overall mixing quality can be increased.

In another embodiment the first objective is satisfied with a static mixer described herein.

In particular a static mixer of the present invention is suitable for mixing together at least two components and comprises: a mixer housing; a mixing inset being arranged at least partly in the mixer housing and wherein the mixing inset comprises a plurality of mixing elements which are connected by at least one peripheral web. Peripheral shall mean that the web is positioned adjacent to the mixer housing in the assembled state and thus between the mixing elements and the mixer housing.

The static mixer of the present invention differs from the prior art such as EP0815929B1 and EP2548634B1 by the feature that the interconnecting peripheral web is at least partly discontinuous.

Such a discontinuity in the present invention fulfils the function of allowing for any undesired flow of material between the mixer housing and the mixing inset to blend with the regular flow which follows a path through the mixing elements. Such an undesired flow may develop because the dimensions of the mixer housing and the mixing inset are usually chosen such that a small gap of around 0.05 to 0.2 mm is present between the mixing inset and the mixer housing for assembly reasons. Furthermore this gap may be wider due to manufacturing tolerances or may increase during operation due to a radial expansion of the mixer housing caused by the pressure of the dispensed materials. Due to the pressure during dispensing, a formation of a gap may even occur when the gap is virtually zero in a pressure-less state. This gap may be entered by some unmixed or poorly mixed material on the inlet side of the static mixer and in the static mixers of prior art this unmixed or poorly mixed material may propagate all the way to the mixer outlet without being subjected to any further mixing. By blending these flows with the regular flow which follows a path through the mixing elements, the overall mixing quality can be increased.

In this connection it should be noted that the embodiment according to which the mixing inset is at least partly provided within the mixer housing means that at least one mixing element of the mixing inset is arranged within the mixer housing and that, for example, components of the mixing inset may project out of the mixer housing. However, it is preferred that all mixing elements are arranged within the mixer housing.

In an embodiment, the peripheral web is completely discontinued in an axial direction. This means that no part of the peripheral web in an upstream direction of the discontinuity is directly connected with any part of the peripheral web in a downstream direction of the discontinuity. This shall not exclude any indirect connections via any baffles of the mixing elements within the interior parts of the mixing elements. This has the advantage that all the unmixed or poorly material which may have entered the gap between the mixer housing and the peripheral web is exposed to the regular flow for blending with it.

In another embodiment, the peripheral web has a plurality of partial discontinuities and the partial discontinuities are located such that a projection in an axial direction forms an area which overlaps a cross-section of said peripheral webs. This has the advantage that all straight line paths in the gap between mixer housing and peripheral web will eventually pass a discontinuity and thus all the unmixed or poorly mixed material which may have entered the gap between the mixer housing and the peripheral web is exposed to the regular flow for blending with it.

Here, the term axial direction shall refer to a mixer axis or a mixing axis. Accordingly, a discontinuity may separate the peripheral web into two portions being arranged in an axial direction relative to each other, in particular in a direction of a mixer axis. Likewise, a discontinuity may at least partially separate the peripheral web into two different web portions arranged at an axial distance relative to each other, in particular in direction of a mixer axis.

In a preferred embodiment, at least one discontinuity is located at a position where a direction of flow of a viscous mass to be mixed is at an angle of at least 30 degrees to an mixer axis. “Viscous mass” shall mean that the viscosity is high enough to yield a laminar flow for the respective mixer dimensions. An example would be a viscosity of 10 Pa s in a mixer housing of 5 mm inner diameter. The flow pattern can be determined with any standard CFD solver, e.g. STAR-CCM+. This has the advantage that the unmixed or poorly mixed material which may have entered the gap between the mixer housing and the peripheral web is pushed sideways upon exposure with the regular flow. Thus a re-entering of the same material into the gap further downstream is prevented or at least reduced. In case the mixer housing is of substantially cylindrical shape, the axis of the mixer shall be the axis of this cylinder. In more complex cases, the axis may be understood as the general overall direction of flow between the mixer inlet and the mixer outlet.

In another preferred embodiment, at least one discontinuity is located between two deflection baffles. Many mixing geometries for which this invention is applicable have a variety of different baffles. Typically, there are divider baffles which are arranged such that a normal vector to their surface is approximately perpendicular to the mixer axis. Such baffles divide the oncoming flow and prepare it for redistribution. Secondly, there are joining baffles which are also arranged such that a normal vector to their surface is approximately perpendicular to the mixer axis. Such baffles realign the flow with the general direction of flow along the mixer axis after a redistribution of flow has taken place. And finally, there are deflection baffles which govern the redistribution of flow. Such deflection baffles are usually arranged with normal vectors at various non-perpendicular angles to the mixer axis. Often, but not necessarily, normal vectors of deflection baffles are substantially parallel to the mixer axis. Deflection baffles may also have complex shapes and curved surfaces. A location of a discontinuity between two deflection baffles has several advantages. First of all, such a location of the discontinuity between two deflection baffles has the advantage that the peripheral web is unaltered at the location of the deflection baffle and thus may provide support to the deflection baffle which leads to increased mechanical stability. Secondly, the regular flow generally changes direction between two deflection baffles and thus the blending of the unmixed or poorly mixed material with the regular flow is improved.

In another preferred embodiment, at least one discontinuity is directly adjacent to a deflection baffle. This has the advantage that the flow direction of the regular flow next to a deflection baffle is usually significantly deflected from the direction of the mixer axis. Thus the poorly mixed or unmixed material is deflected sideways if exposed to the regular flow, and therefore a re-entering of the same material into the gap further downstream is prevented or at least reduced.

In another preferred embodiment, at least one discontinuity has an axial extension of less than a length of a mixing element. This has the advantage that the remaining peripheral web can provide stability to the mixing inset.

In another preferred embodiment, every peripheral web comprises at least one discontinuity. This has the advantage that there is no peripheral web with a continuous gap between the peripheral web and the mixer housing. In a more preferred embodiment each discontinuity is located at a different mixing element. This has the advantage that the mechanical stability is improved over an embodiment with two or more discontinuities per mixing element.

In another preferred embodiment, the at least one discontinuity is located in a middle section of the set of mixing elements. Middle section means a section starting at 25% of the total length of the set of mixing elements and ending at 75% of the total length of the set of mixing elements. Set of mixing elements shall mean the entirety of all mixing elements irrespective whether they are connected by peripheral webs or not. The set of mixing elements shall not include any additional structures like a mixer head. This location is beneficial for the following reason. Any material that enters the gap close to the inlet side blends with the regular flow at the location of the discontinuity. If the discontinuity is located too far towards the mixer outlet, i.e. further than 75% of the total length, there is a risk that unmixed or poorly mixed material may propagate close to the outlet region and—after blending with the regular flow at the position of the discontinuity—the remaining distance to the outlet may not suffice for effectively mixing this unmixed material properly with the regular flow of the material. Furthermore, right after any discontinuity, material of the regular flow will newly enter the gap between the peripheral web and the mixer housing. Conversely if the discontinuity is located too close to the inlet, i.e. less than 25% of the total length, there is a risk that the material in the regular flow is not yet sufficiently mixed. And thus poorly mixed material may propagate in the gap all the way to the outlet.

In another preferred embodiment, the peripheral webs of the mixing inset are essentially two parallel plates preferentially featuring discontinuities on both plates. The advantage of the parallel plates is that such shapes can be easily manufactured. Furthermore, the plates provide stability to the mixing inset. Discontinuities on both plates are preferred because thereby the unwanted flow on both gaps between each of the plates and the mixer housing is exposed to the regular flow for blending with it.

In yet another preferred embodiment, the peripheral webs of the mixing inset are essentially four parallel bars preferentially featuring discontinuities on both plates. The advantage of the four parallel bars is that such shapes can be easily manufactured. Furthermore, the bars provide stability to the mixing inset. Discontinuities on all four bars are preferred because thereby the unwanted flow on all gaps between each of the bars and the mixer housing is exposed to the regular flow for blending with it. Such bars are most preferred in combination with mixing elements comprising the features described in detail in EP2548634B1 (“mixing elements” within the scope of this application are referred to as “installation bodies” in EP2548634B1).

The second objective of this invention is satisfied with a kit of parts comprising a static mixer of the present invention, a two component cartridge suitable for connecting to said static mixer and for dispensing the two components through said static mixer and mixing said components thereby and optionally a dispensing gun. This has the advantage of improved mixing quality of the dispensed materials.

In a preferred embodiment of the kit of parts, the two component cartridge is filled with materials to be dispensed in particular with dental impression material, dental crown and bridge material, chemical anchoring material, sealing material or industrial adhesives. This has the advantage of improved mixing quality of the dispensed materials.

The third objective of this invention is satisfied with using a static mixer of the present invention for mixing two component materials, in particular dental impression materials, dental crown and bridges materials, chemical anchoring materials or industrial adhesives.

### BRIEF DESCRIPTION OF THE DRAWINGS

The invention will be explained in more detail hereinafter with reference to the drawings.

FIG. 1 illustrates a prior art static mixer;

FIG. 2 illustrates a prior art mixing inset;

FIGS. 3A, 3B and 3C illustrate prior art alternative geometries of mixing elements;

FIG. 4 illustrates a cross-sectional view of FIG. 1;

FIG. 5 is a partial view of a mixing inset of an embodiment of the invention;

FIG. 6 is a partial view of a mixing inset of another embodiment of the invention;

FIG. 7 is a partial view of a mixing inset of another embodiment of the invention;

FIG. 8 is a partial view of a mixing inset of another embodiment of the invention; and

FIG. 9 is an axial position of discontinuity on mixing inset of the invention.

### DETAILED DESCRIPTION OF THE EMBODIMENTS

In the following, the same reference numerals will be used for parts having the same or equivalent function. Any statements made having regard to the direction of a component are made relative to the position shown in the drawing and can naturally vary in the actual position of application.

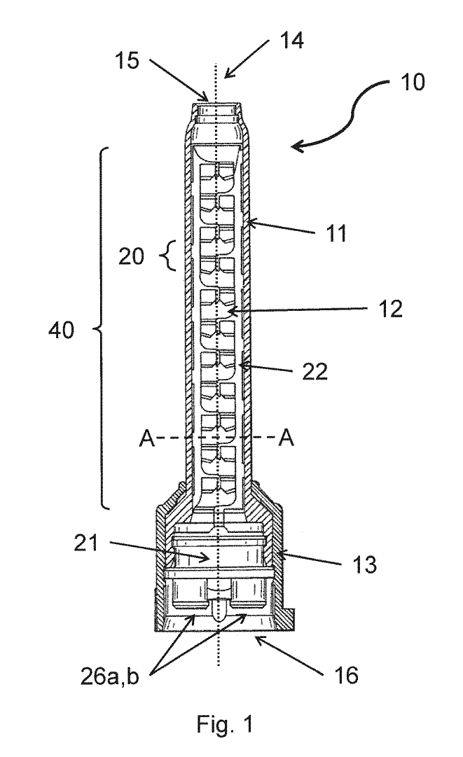

FIG. 1 shows a sectional side view of a static mixer 10 known from prior art document EP2548634B1. This static mixer 10 features a longitudinal mixer axis 14, and comprises a mixer housing 11, a mixing inset 12 and a connection element 13 for attaching the mixer inlet 16 to a suitable two-component cartridge. The mixing inset 12 comprises a mixer head 21 featuring passageways 26a, 26b which couple to the matching cartridge outlets. The passageways 26a, 26b guide the two materials to the set of mixing elements 40 where they are mixed together. After passing the set of mixing elements, the mixed materials are dispensed through the mixer outlet 15. The set of mixing elements 40 comprises a multitude of individual mixing elements 20 which are interconnected by peripheral webs 22. The mixing inset 12 and part of the mixer head are arranged within the mixer housing 11.

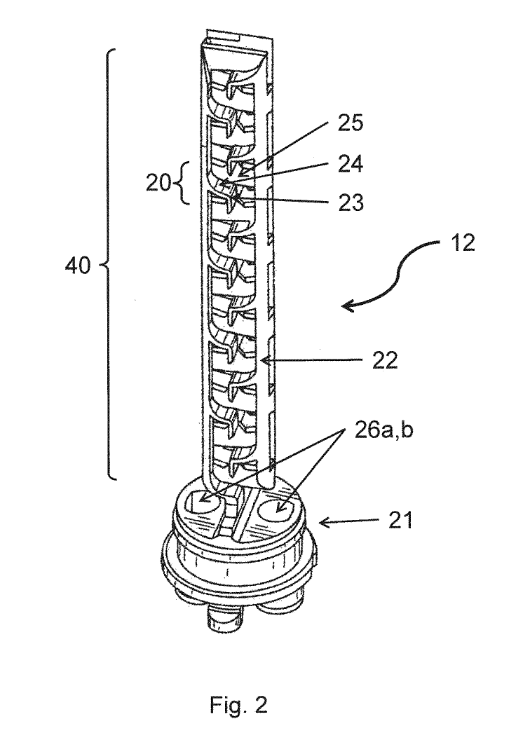

FIG. 2 shows the prior art mixing inset 12 of FIG. 1 in a three-dimensional view. The mixing elements 20 essentially include various baffles, in particular a divider baffle 23, deflection baffles 24 and a joining baffle 25. The divider baffle 23 separates the oncoming flow of material into two sub-flows. These sub-flows are deflected and thus rearranged by the deflection baffles 24. Subsequently, the flows are joined again after having passed the joining baffle 25. More details of this mixing process are described in documents EP2548634B1 and also EP0815929B1.

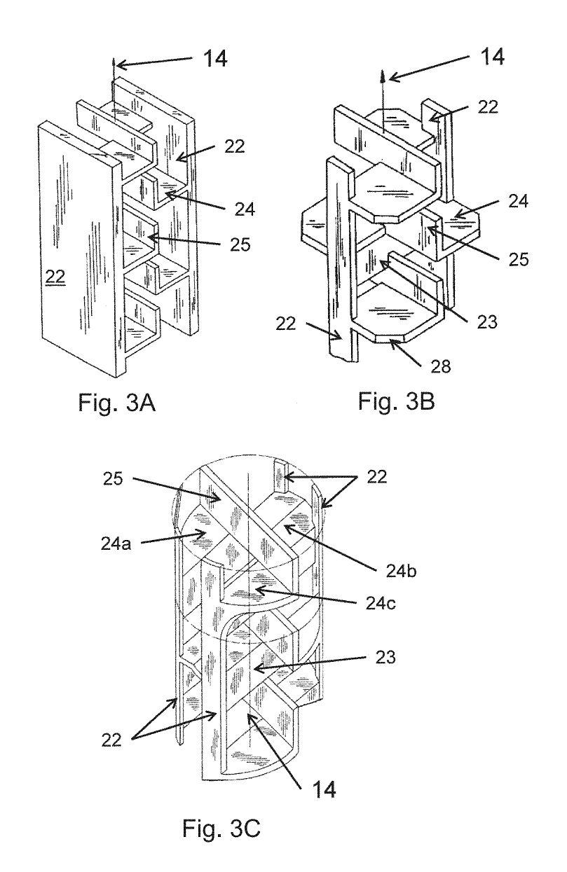

FIGS. 3A-3C show a variety of mixing geometries known from prior art documents EP2548634B1 and EP0815929B1. All of them utilize the basic mixing principle of dividing the material flow into sub-flows, deflect and rearrange the sub-flows and joining the sub-flows again. Also, they share the common feature that the mixing elements 20 are inter-connected by peripheral webs 22. The peripheral webs 22 in FIGS. 3A and 3B are substantially parallel plates. In the example of FIG. 3A, the plates extend over the full lateral dimension of the mixing elements 20. In the example of FIG. 3B, said plates are laterally much smaller the mixing elements 20. In the example of FIG. 3C, the mixing elements are inter-connected by four peripheral webs 22 which have the shape of rods or bars. The mixing geometry of FIG. 3A is for use in a mixer housing of substantially quadratic cross-section. The mixing geometry of FIG. 3B may also be used in a mixer housing of substantially quadratic cross-section or in an octagonal cross-section depending on the actual size and shape of the cut corners 28 of the deflecting baffles 24. The mixing geometry of FIG. 3C is for use in a mixer housing of substantially circular cross-section.

The mixing elements in FIG. 3A also feature divider baffles 23 although they cannot be seen in this particular view.

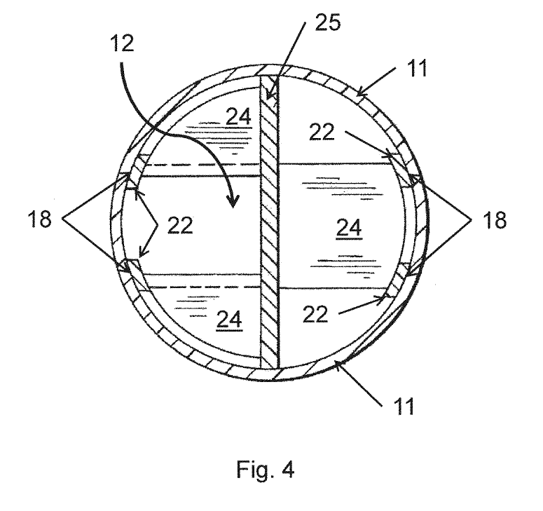

FIG. 4 shows a cross-section of the prior art static mixer 10 of FIG. 1 along the plane A-A. The peripheral webs 22 are adjacent to the mixer housing 11. Between each of the peripheral webs 22 and the mixer housing 11 exists a small but nevertheless noticeable gap 18. This gap 18 is necessary to render the assembly of the mixing inset 12 into the mixer housing 11 possible. In current products on the market it is in the range of 0.05 to 0.2 mm. The width of the gap 18 may vary because of dimensional differences of the mixer housing 11 and the mixing inset 12 due to manufacturing variations. Furthermore the mixing inset 12 may be slightly tilted or bend inside the mixer housing 11. This may be increasingly so under the forces exerted on the baffles 23, 24, 25 by the passing viscous material. The gap 18 extends throughout the whole set of inter-connected mixing elements 40 and allows for material to bypass the mixing process and flow directly to the mixer outlet 15. Such a flow of un-mixed material is often seen as a discoloured streak in the bead of dispensed material.

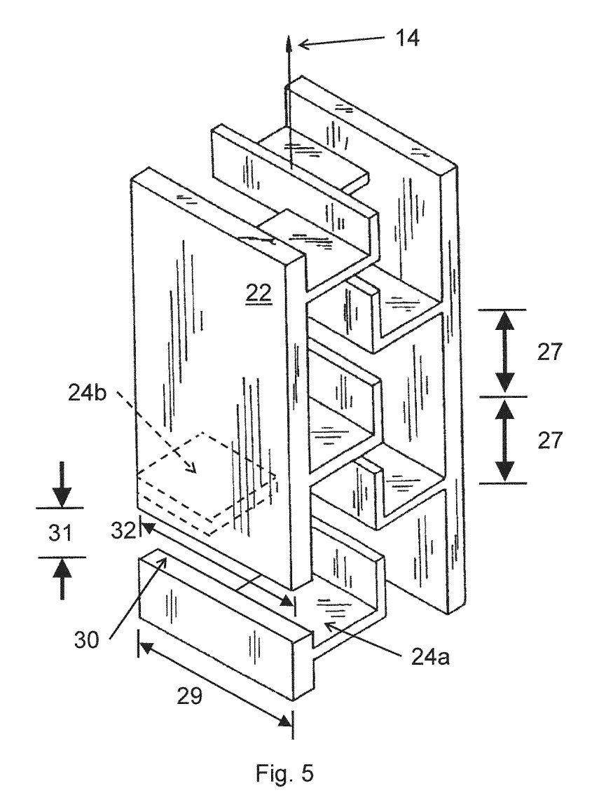

FIG. 5 shows a three dimensional partial view of a mixing inset 12 in accordance with the present invention. In particular it shows several of the mixing elements 20 interconnected by peripheral webs 22 in the shape of parallel plates. The plates extend over the full width of the mixing elements. One of the peripheral webs 22 is discontinued in at least one position. The discontinuity 30 has a length 31 in the direction of the mixer axis 14 and a width 32 in a direction perpendicular to the mixer axis 14 and in the plane of the peripheral web 22. The discontinuity 30 therefore separates the peripheral web 22 into two portions arranged in an axial direction relative to each other, in particular in a direction of the mixer axis 14. In this example, the width of the discontinuity 32 is equal to the width of the peripheral web 29. This has the effect that any material that may flow on the outside of the peripheral web 22, i.e. in the gap 18 between the peripheral web 22 and the mixer housing 12, is exposed to the regular flow following a path through the mixing elements 20 and blends with it. So a direct propagation of material is hindered from—or at least reduced in quantity—following a direct path in the gap 18 from close to the mixer inlet 16 to the mixer outlet 15.

The length of the discontinuity 31 in this example is about 60% of the length of a mixing element 27. Furthermore, the discontinuity is located such in relation to the axial direction that it is entirely located between subsequent deflection plates 24a and 24b, the latter being concealed by the peripheral web 22 in this view. This has the effect that both deflection plates are supported by the peripheral web 22 and thus mechanical stability is largely conserved.

Although FIG. 5 only depicts a discontinuity in the front facing peripheral web, a discontinuity may preferentially also be present in the rear facing peripheral web. This prevents the flow of unmixed or poorly mixed material to the outlet 15 also on that side. More preferred is that the second discontinuity is located at a different mixing element than the first discontinuity. This avoids an unnecessary mechanical weakening of the mixing inset as a whole.

The discontinuity 30 may also be located preferentially directly adjacent to a deflection baffle 24a or 24b. Close to such deflection baffles, the regular flow has a direction at a large angle relative to the mixer axis 14. More generally, it is preferred to locate a discontinuity such that it covers an area where the regular flow is at an angle to the mixer axis. More preferred this angle is at least 30 degrees.

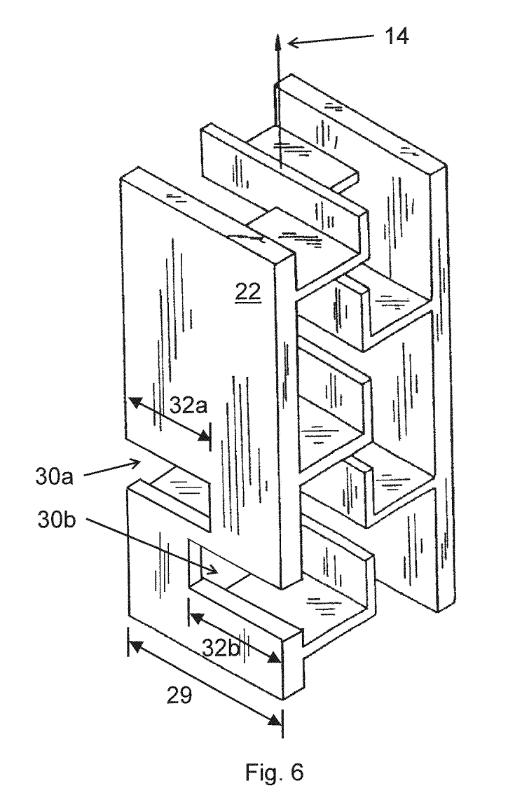

FIG. 6 shows an alternative embodiment of the present invention. In contrast to the example of FIG. 5, the peripheral web 22 features two partial discontinuities 30a and 30b with widths of 32a respectively 32b. Each discontinuity 30a and 30b may at least partially separate the peripheral web 22 into two different web portions arranged at an axial distance relative to each other, in particular in direction of the mixer axis 14. The sum of width 32a and 32b is greater than the width of peripheral web 29. Furthermore, the discontinuities are located such that their area overlaps in direction of the mixer axis 14. Accordingly, the peripheral web has a plurality of partial discontinuities 30a and 30b, which are located such that their projection in an axial direction forms an area which overlaps a cross-section of said peripheral web. Therefore, the projection in an axial direction may form an area which corresponds to a cross-section of the peripheral web, i.e. completely covers the cross-section of the peripheral web. In other words, any straight flow path parallel to the mixer axis in the gap 18 passes by at least one of the discontinuities. Thus material flowing in the gap is exposed to the regular flow through the mixing elements and blends with it.

Such partial discontinuities have the advantage of helping to maintain the mechanical stability better than the full discontinuities shown in FIG. 5. And similar to the embodiment of the full discontinuities, it is preferred, that also the rear facing peripheral web comprises a partial discontinuity. Partial discontinuities have the advantage that they might be placed such that the same mixing element may comprise more than one while maintaining sufficient mechanical stability.

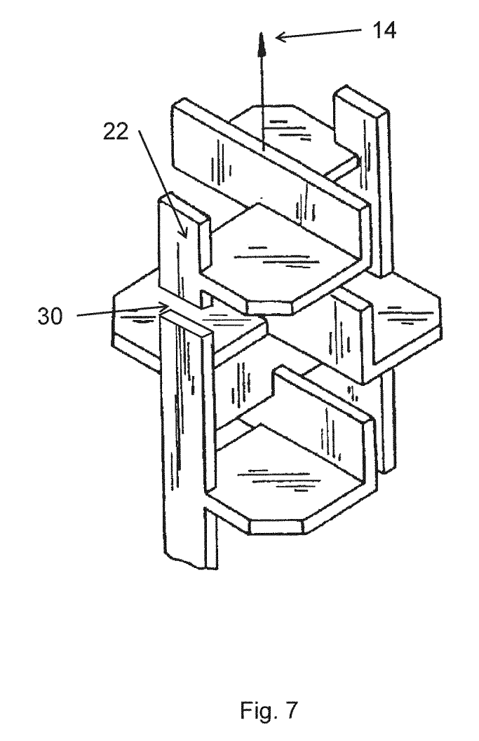

FIG. 7 shows another embodiment of the present invention. The peripheral webs 22 do not extend over the full width of the mixing element. Exemplarily, a single full discontinuity 30 is depicted. Nevertheless, also partial discontinuities are possible with this kind of mixing elements and this kind of peripheral webs 22. And, as described above, it is preferred that both peripheral webs 22 comprise at least one partial or full discontinuity.

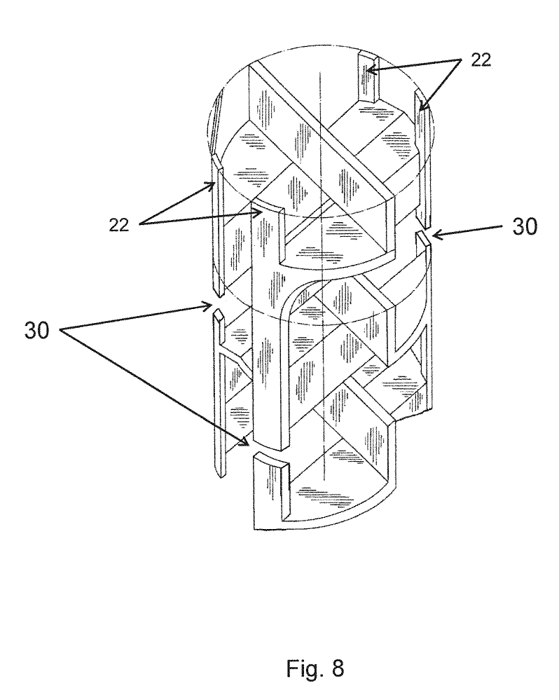

FIG. 8 shows another embodiment of the present invention. The mixing geometry is different to that of the earlier examples, and the mixing elements are interconnected by 4 peripheral webs 22. Exemplarily, three discontinuities 30 are depicted in various locations. Nevertheless, also partial discontinuities are possible with this kind of mixing elements and this kind of peripheral webs 22. And, as described above, it is preferred that all four peripheral webs 22 comprise at least one partial or full discontinuity.

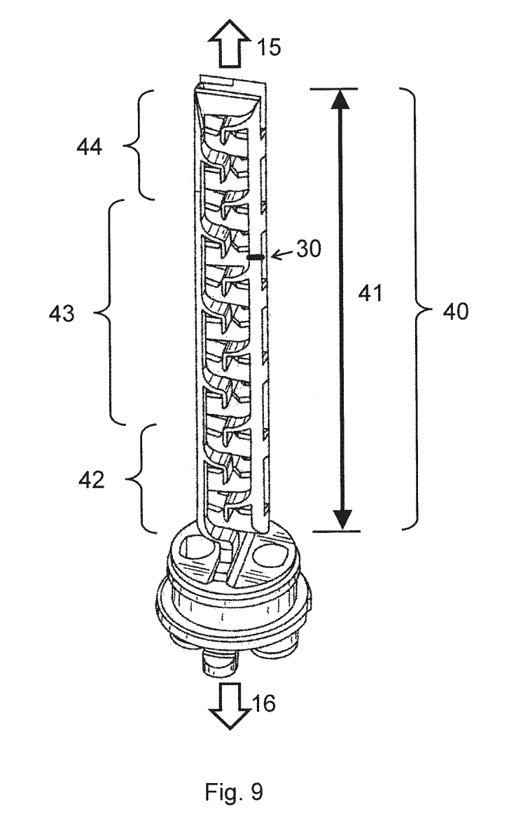

FIG. 9 shows a mixing inset 12 with a total length 41 of the set of mixing elements 40. This set of mixing elements can be divided into three sections, namely a start section 42, a middle section 43 and an end section 44. The start section 42 shall start at 0% of the total length 41, i.e. with the mixing element 20 closest to the mixer inlet 16. The start section shall end at 25% of the total length 41. The middle section 43 shall extend from 25% of the total length 41 to 75% of the total length 41. The end section 44 shall extend from 75% of the total length 41 to 100% of the total length 41, i.e. the last mixing element 20 closest to the mixer outlet 15.

In FIG. 9, the location of a discontinuity 30 is indicated by a thick line without showing it actually in detail. It is preferred if any discontinuity 30 is located in the middle section 43. If it would be located too close to the mixer inlet 16, like in the start section 42, it would allow material which has only passed very few mixing elements 20 to enter the gap 18 right at the discontinuity 30. Such material is only poorly mixed and might propagate unhindered towards the mixer outlet 15. Conversely if it would be located too close to the mixer outlet 15, like in the end section 44, this would allow unmixed material to propagate from the mixer inlet 16 to a region close to the mixer outlet 15 with only few mixing elements 20 left to blend in the unmixed material. Both scenarios are preferentially avoided. In general, all the mixing insets shown may also be at least partly inserted into a mixer housing to form a static mixer in accordance with the present invention.

It should further be noted that the discontinuities may also be oriented differently than being perpendicular to the mixer axis as shown. Also, the discontinuities may have any other regular or irregular shape other that the depicted rectangular shape provided that they fulfill the function of exposing the flow in the gap 18 to the regular flow through the mixing elements.

It should be noted that any of the foregoing embodiments may be combined with any other embodiment as long as technically feasible.

1. A mixing inset for a static mixer,. comprising:
a plurality of mixing elements interconnected by at least one peripheral web, the peripheral web being at least partly discontinuous.

2. A static mixer for mixing together at least two components comprising:
a mixer housing; and
a mixing inset arranged at least partly in the mixer housing,
the mixing inset comprising a plurality of mixing elements which are connected by at least one peripheral web;
the at least one peripheral web being completely discontinuous in an axial direction or the at least one peripheral web having a plurality of partial discontinuities, the partial discontinuities being located so as to project in an axial direction to form an area which overlaps a cross-section of the peripheral webs.

3. The static mixer according to claim 2, wherein at the least one peripheral web is discontinuous at a position along a length of a mixing element of the plurality of mixing elements where a direction of the flow of a viscous mass within the mixing element is at an angle of at least 30 degrees to a mixer axis.

4. The static mixer according to claim 2, wherein the at least one peripheral web is discontinuous between two deflection baffles.

5. The static mixer according to claim 2, wherein the at least one peripheral web is discontinuous is directly adjacent to a deflection baffle.

6. The static mixer according to claim 2, wherein the at least one peripheral web is discontinuous so as to form a discontinuity having an axial extension of less than a length of a mixing element of the plurality of mixing elements.

7. The static mixer according to claim 2, the at least one peripheral web includes a plurality of peripheral webs and each peripheral web of the plurality of peripheral webs comprises at least one discontinuity and each discontinuity is disposed adjacent to a different mixing element from each other discontinuity.

8. The static mixer according to claim 2, wherein the at least one peripheral web is discontinuous at a middle section of the plurality of mixing elements.

9. The static mixer according to claim 2, wherein the at least one peripheral web of the mixing inset includes a plurality of peripheral webs, and the plurality of peripheral webs are two parallel plates.

10. The static mixer according to claim 2, wherein the at least one peripheral web of the mixing inset includes a plurality of peripheral webs, and the plurality of peripheral webs are four parallel bars.

11. A kit of parts comprising:
a static mixer according to claim 2;
a two component cartridge configured to connect to the static mixer and dispense the two components through the static mixer and thereby mix the components.

12. A method of operating the mixing inset according to claim 1, the method comprising:
operating the mixing inset to mix two component materials.

13. A method of operating the static mixer according to claim 2, the method comprising:
operating the static mixer to mix two component materials.

14. The mixing inset for a static mixer according to claim 1, wherein
the at least one peripheral web is completely discontinuous in an axial direction or the at least one peripheral web has a plurality of partial discontinuities, the partial discontinuities being located so as to project in an axial direction to form an area which overlaps a cross-section of the peripheral webs.

15. The static mixer according to claim 9, wherein each of the two parallel plates include a discontinuity.

16. The static mixer according to claim 10, wherein each of the four parallel bars include a include a discontinuity.

17. The kit according to claim 11, further comprising
a dispensing gun, and the two component cartridge is filled with a dental impression material, a dental crown and bridge material, a chemical anchoring material, a sealing material or industrial adhesives
